(19) United States
(12) Patent Application Publication
(10) Pub. No.: US 2008/0164759 A1
(43) Pub. Date: Jul. 10, 2008

(54) REDUNDANT POWER SUPPLY ARCHITECTURE WITH VOLTAGE LEVEL RANGE BASED LOAD SWITCHING

(76) Inventors: Viswa Sharma, San Ramon, CA (US); David Lentz, Hopkins, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/969,671

(22) Filed: Jan. 4, 2008

Related U.S. Application Data
(60) Provisional application No. 60/883,444, filed on Jan. 4, 2007.

(51) Int. Cl. H02J 1/10; H02J 3/38; H02J 7/34

(52) U.S. Cl. 307/52

(57) ABSTRACT

A voltage level range based redundant power supply architecture is described wherein at least two power supplies are connected to an external load and maintained in an energized state. However, only one of the power supplies sources all the current requirements of the load while the other power supply remains in standby mode. This is achieved by manually or programmatically adjusting the voltage output of a first power supply and a second power supply connected in parallel to the external load such that the first power supply always outputs a higher potential difference at the point of load than the second power supply, thereby implementing a voltage level range of outputs of the power supplies so as to guarantee that all the current requirement of the load is sourced from the first power supply. The second power supply remains energized and upon failure of the first power supply instantaneously takes over the function of the failed power supply and powers the load.

### PRIORITY APPLICATION

The present application claims priority to U.S. Provisional Application Ser. No. 60/883,444, filed Jan. 4, 2007, the disclosure of which is hereby incorporated by reference.

### FIELD OF THE INVENTION

The present invention relates generally to the field of power supply architectures for powering high availability systems, and in particular to redundancy and fault tolerant power supply configurations.

### BACKGROUND OF THE INVENTION

The Power Sources Manufacturers Association's (PSMA) Handbook of Standardized Terminology for the Power Sources Industry defines a power supply as a device for the conversion of available power of one set of characteristics to another set of characteristics to meet specified requirements. Power supplies are alternatively referred to as power converters. Typical applications of power supplies include conversion of ubiquitous Alternating Current (AC) power to a controlled or stabilized Direct Current (DC) for the operation of electronic equipment. These types of power supplies are called AC-DC converters. DC-DC power converters are utilized in situations where a conversion from one DC voltage needs to be converted to another DC voltage. The output voltage of a power supply is typically controlled to work within a range of voltages, against changes in the input voltage or changes in the load current. A voltage regulator is used to control the output power. The voltage regulator contains specialized control circuitry that regulates output to the desired value, provided the input voltage and the load current are within the specified operating range for the voltage regulator.

Depending on the mode of regulation employed by the voltage regulating circuitry, a power supply can be categorized either as a linear power supply or as a switched mode power supply (SMPS). A linear power supply incorporates control circuitry to adjust the resistance of the power supply output circuit to cope with changes in the input voltage or load current such that the output voltage is kept substantially constant. This mode of control leads to substantial losses in the form of heat and therefore, the linear regulator is generally inefficient. To overcome this deficiency with linear power supplies SMPS are used.

In a conventional SMPS, the input DC voltage to the SMPS is switched with a periodic waveform or a pulse, operating at a preset switching frequency. The duty cycle is defined as the ratio of switch on time to the period of the pulse (Switch ON Time+Switch Off Time). In the SMPS the regulation is achieved by modulating the duty cycle or pulse width. These types of regulators are called Pulse Width Modulators (PWM).

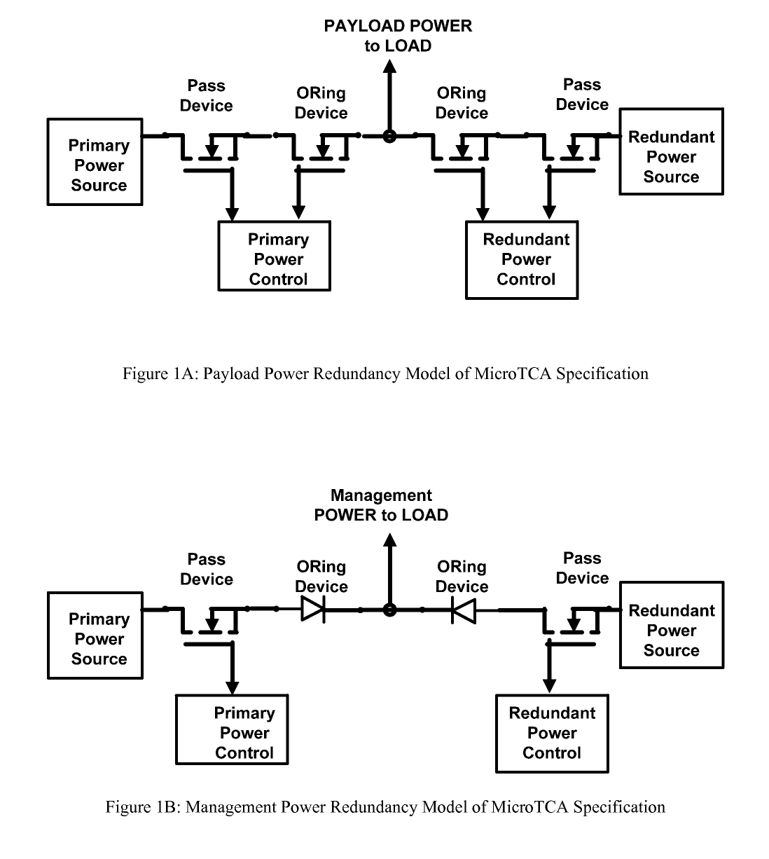

Output feed back circuits are typically used for regulating the power supply output. There are generally two types of feedback methods used for an SMPS, an analog feedback loop, exemplified by U.S. Pat. No. 5,600,234, and a digital feedback loop, exemplified by U.S. Pat. No. 5,675,240. Each of the feedback loops has associated therewith a voltage sense input for sensing the supply output voltage and PWM for modulating the switching pulses for driving switches. An exemplary, analog feed back circuit is schematically shown in FIG. 1 of U.S. Pat. No. 5,600,234. The sensed voltage is compared a reference voltage, in the analog domain, typically using a voltage comparator, to generate an error voltage. The error voltage is used to modulate the pulse width to provide the desired output. The varying output voltage produces a range of error voltages at the comparator, which modulates the duty cycle of the PWM or adjusts the pulse width to adjust the output voltages to operate within the specified range.

An exemplary digital controller is schematically shown in FIG. 1 of the U.S. Pat. No. 5,675,240. The voltage signal sense input utilizes an analog-to-digital converter (ADC) to convert the output voltage to a digital value and then compare this digital value to a desired reference voltage to determine the difference as an error voltage. The resultant digital error voltage is then used to modulate the pulse width of the PWM. In all of the above cases, the regulation methodologies require complex control circuitry which reduces the inherent reliability and conversion efficiency of the regulated power supply and also increases the cost and complexity of the power supply.

In high availability power supply systems, enhanced system reliability is typically obtained by adding at least one other power supply module in parallel with one or more functioning power supplies in a redundant configuration such that a failure of a functioning power supply causes the additional power supply to take over the function of the failed power supply. Such a redundant configuration is generally realized by directly connecting a pair of power supplies, each of which being a DC-DC converter for example, in parallel to a load. In an active redundant configuration, where both power supplies are energized, the power supply presenting the higher voltage potential at the load will source the entire current requirement of the load. Traditionally, this power supply is designated the primary power supply or master power supply. In the event the primary power supply fails, the redundant power supply is immediately available to source current to load.

One of the problems associated with an active redundant configuration is that there is no mechanism to prevent current flow from the redundant power supply to the primary power supply should the primary power supply fail. To remedy this problem, prior art power supplies incorporate a freewheeling diode (also referred to as the ORing diode) coupled in a forwardly biased arrangement between the power supply and the load. This ORing diode is reverse biased for a current flow directed into the power supply, thus preventing such a reverse current flow for any voltage below the diode's reverse breakdown voltage. In effect, the ORing diode allows current to flow from the power supply to the load but presents a barrier to any current attempting to flow into the power supply from the load or the other power supplies connected to the load.

One of the other problems associated with an active redundant configuration is the ability to make one of the supplies to be the primary supply to source the load the other supply to be redundant or back up power supply. In the case when the primary power supply voltage is substantially equal to the voltage of the backup power supply, load current can be drawn from both the primary power supply and from the backup power supply. If the back power supply is at a higher potential than the primary the back up sources the entire load. If the backup power source is a battery or a backup source as in uninterruptible power source (UPS), this arrangement would cause the battery or UPS to supply the load even in the absence of the primary power supply failure thereby shortening the life of the battery or defeating the purpose of the UPS power supply. Such unpredictable behavior can pose a problem in most applications and is undesirable.

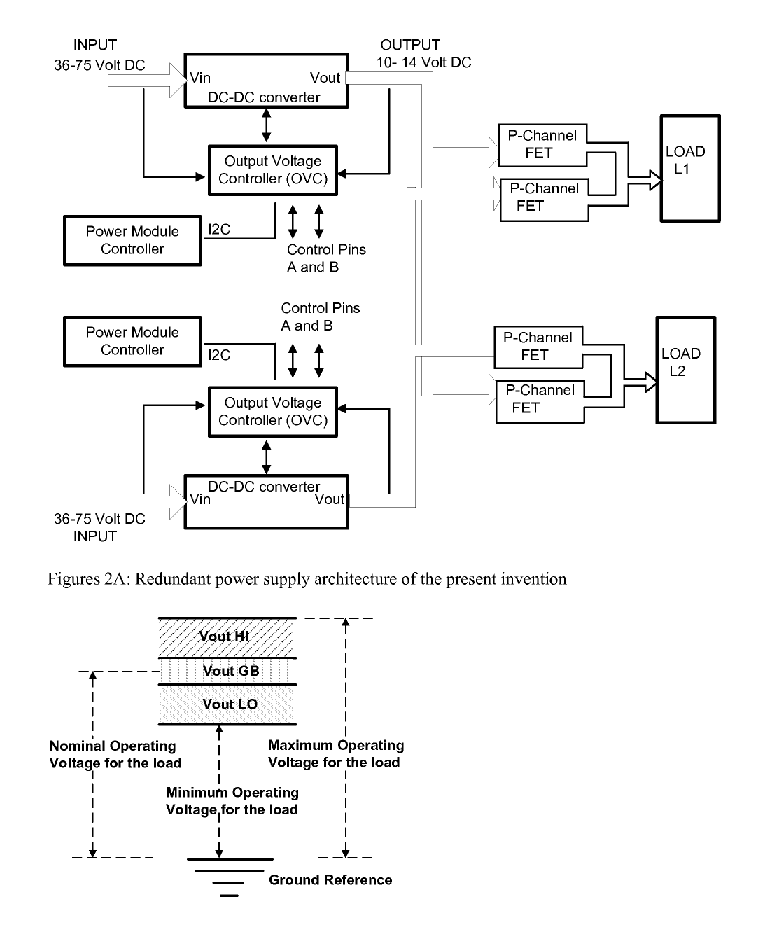

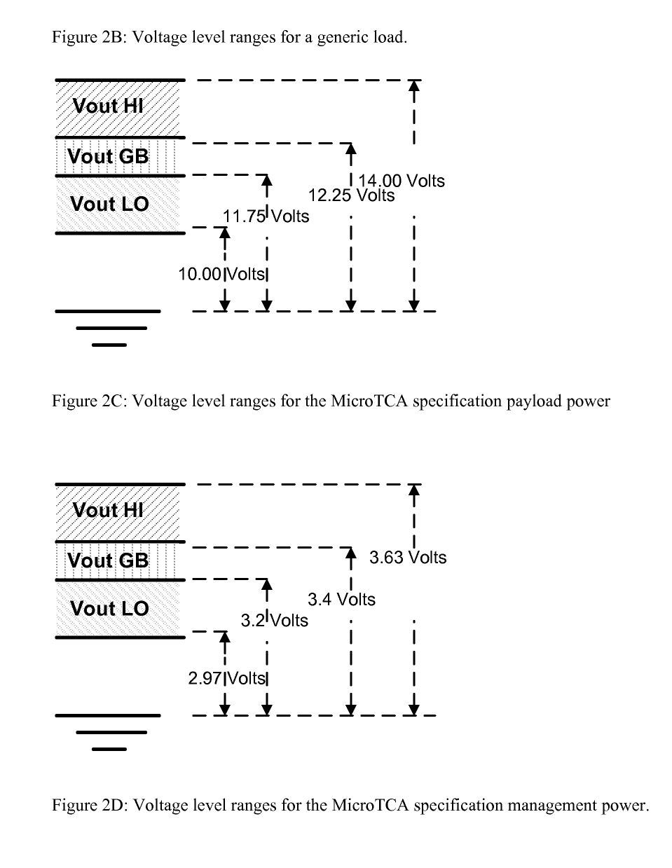

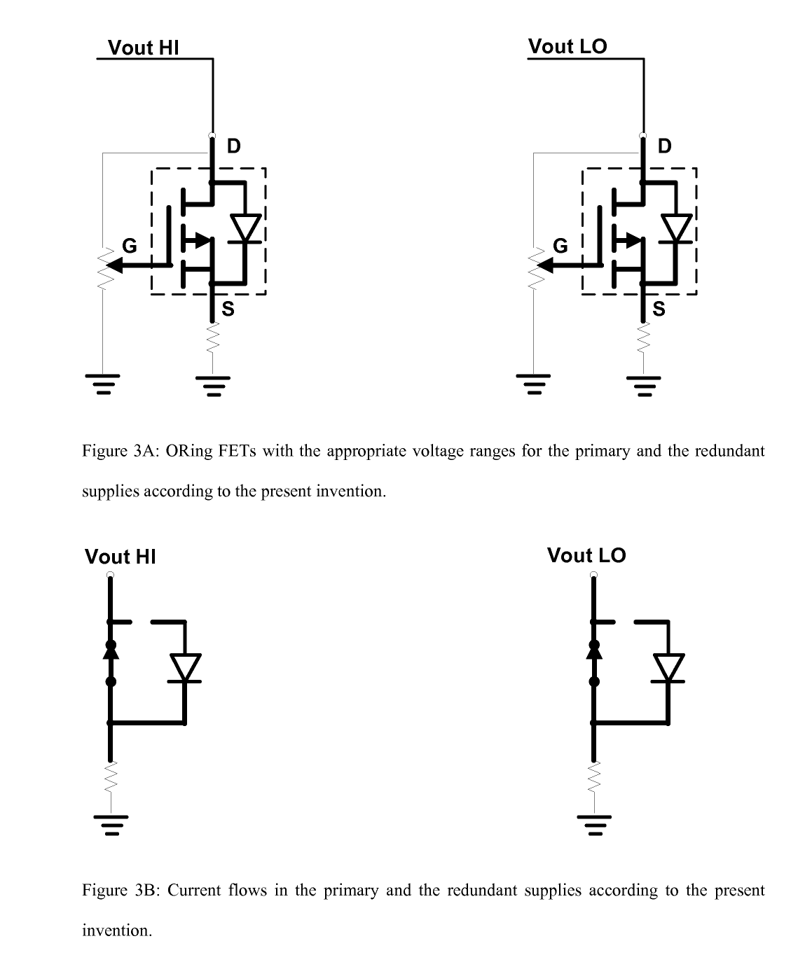

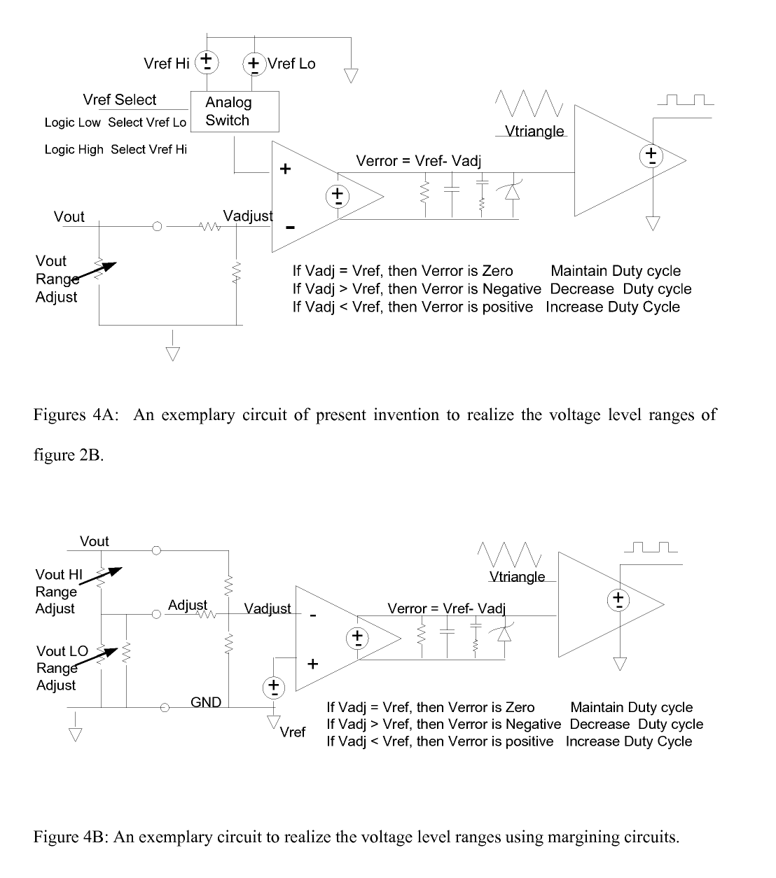

One solution to the aforementioned problems is described in U.S. Pat. No. 4,788,450 in which a solid-state power switch, a P-channel metal-oxide semiconductor (MOS) field-effect transistor (FET) or MOSFET switch, is used in place of the ORing diode as shown in the FIG. 2a of U.S. Pat. No. 4,788,450 ('450 patent). The P-channel FET has an intrinsic junction diode or alternatively body diode. The FET offers lesser resistance than the body diode. In normal usage, when the FET is turned On the current flows through the lesser resistance path through the FET, the body diode is, therefore, effectively out of circuit. As shown in FIG. 2b of the '450 patent, when the switch is turned Off, the current flows through the body diode. A control circuit as shown in the FIG. 3 of the '450 patent controls the gate voltage relative to the source voltage of each transistor to selectively turn the FET On or turn the FET Off. In a redundant configuration, with two P-channel FETs in parallel with the load, assuming voltage feeding to the FETs of the primacy and redundant power supplies are nearly equal, then Turning FET On for the primary and turning the FET Off for the secondary power supply, forces the primary to be at higher potential than the redundant supply, because the resistance of the diode path is higher than the switch path and the redundant path offer a greater voltage drop. The current flows through the switch and no load current flows through the Oring diode. While the use of such a solid-state power switch addresses the problem of using a power supply in a redundant configuration to be primary or standby or redundant source, the primary and secondary supplies are to be at nearly equal potential or with in reasonable tolerance such that the diode drops assures sufficient voltage margin to control a power supply to be the primary or to be the standby source.

A variation of this kind of solid-state power switch redundant power supply arrangement has been prescribed in the PICMG® Specification MTCA.0 R1.0, Micro Telecommunications Computing Architecture Base Specification, Jul. 6, 2006” (hereinafter the “MicroTCA Specification”). The MicroTCA specification support a total 16 loads, comprising logic units and cooling units. Each load's power source must be independently monitored and controlled by a power supply. The power supply and the loads are collocated in a chassis or sub rack. A chassis or sub rack may contain one more or power supplies to the supply the load. A MicroTCA power subsystem may support additional functionality such as redundancy. The MicroTCA redundancy specification requires that each load must be supplied by only one power supply (i.e. the primary power supply) while at least one other power supply (redundant power supply) must remain connected to the load in parallel with the primary power supply and must be maintained in an energized state. If the primary supply fails, the redundant supply should provide power instantaneously so that there is no disruption in the operation of the electronic circuitry supported by the load.

The MicroTCA specification employs the state of the art diode drop method of redundancy. The MicroTCA specification provides two types of power for each of the loads, 3.3 Volts+/−10% management power at 150 mili-amperes, and 12V+/−17% Payload Power at 6.7 amperes. The diode drop method does meet the requirements of power supply redundancy, and in the event of failure, to assure glitch-less operation of the electronic circuitry supported by the loads. However, because redundancy is based on diode drops, the MicroTCA specification prescribes careful consideration of the voltage drops in the primary and redundant paths. Specifically, for the payload power, the MicroTCA redundancy specification utilizes a combination of an N-Channel PASS FET as a switch and a P-Channel FET as an ORing-Diode (alternatively “ORing-FET”) to implement a high availability redundant power source. This is shown schematically in FIG. 1A: Payload Power Redundancy Model of MicroTCA specification.

The MicroTCA specification details the steps in the method of operation of the payload channel under normal conditions as follows: 1) the primary and redundant sources of payload power, prior to the switches, are at essentially the same voltage. 2) Both the ORing device and the Pass device in the primary path are turned “ON”. 3) Only the Pass device in the redundant path is turned “ON”. 4) The ORing FET in the redundant path is controlled “OFF”, and its intrinsic body diode is reverse biased. 5) Therefore, the load will be fed through the primary path, and the redundant path is in “standby.” 6) If the primary payload power fails, the load will be fed from the redundant payload power source through the diode provided by the ORing device.

The MicroTCA standard requires that the primary power module should be controlled such that the payload power output voltage is between 12.25 and 12.95 V DC over all normal operating conditions, inclusive of line, load, and temperature. The redundant power module output, with the Pass FET turned On and ORing FET turned Off, should be controlled so that the payload power output voltage is between 11.30 and 12.00 V DC at no load and over all other normal operating conditions, inclusive of line and temperature. In effect, the Diode and other drops are forced to be controlled to be at 0.95 Volts. This requirement translates to a nominal primary supply output voltage of 12.55+/−2.8% volts at the load.

In contrast to the diode drop based redundancy requirement of a nominal 12.55 Volt+−2.8% outputs, the loads supported by MicroTCA specification are designed to operate with payload power in the range of 10 to 14 V or nominal 12 Volts+/−17% (see PICMG AMC.0 R1.0, REQ 4.5). As a result, the advanced technology of higher density, higher efficiency, low cost semi-regulated power converters with a regulation of +/−5% or the unregulated power converters with a line regulation of +/−10% and load regulation of +/−1.5% cannot be used with conventional designs of redundant power supplies that must meet the requirements of the MicroTCA specification.

The MicroTCA redundancy specification utilizes a combination of an N-Channel PASS FET as a switch and an ORing-Diode to implement a high availability redundant power source for management power. This is shown schematically in FIG. 1B: Management Power Redundancy Model of the MicroTCA Specification. The operation under normal conditions for Management Power redundancy is described as follows: 1) The Pass devices in both primary and redundant paths are turned “ON”. 2) Loads will be fed through either the primary path or the redundant path, or both, depending on power source “set points” and voltage drops in the power distribution paths.

It is noted in the specification that the forward Voltage drop of a diode can be a significant percentage of the 3.3 V and so a MOSFET switch based ORing FET is not required. Although the management power is in the range of 3.3 V±10% (see PICMG AMC.0 R1.0, REQ 4.9) since the diode drop can be significant, predictable control of a supply to source the management power and the other supply to be redundant source, is dropped.

What is needed is a robust power supply redundancy architecture that can meet the redundancy requirements of standards like the MicroTCA specification and other similar systems, while overcoming the limitations of the diode-drop based redundancy configuration and provide higher power densities to meet the reduced space requirements, with smaller thermal losses, lower component cost, simple circuitry, and non-complex control to provide non disruptive service in the event of a failure of one source.

### SUMMARY OF THE INVENTION

The present invention provides methods and apparatus to realize a voltage level range based load switching, redundant, power supply architecture that includes at least two power supplies connected in parallel to a load and maintained in an energized state. Each power supply is connected to the load via a FET OR circuit. In one embodiment, each power supply output voltage is provided by any regulated, semi-regulated or unregulated power supply that is adjustable using one of several external control mechanisms such as open loop feedback or closed loop feedback or voltage feed forward method. The output voltage level of each power supply may be adjusted manually, programmatically or automatically using an appropriate biasing circuit which can be controlled remotely. In operation, the output voltage level range of a first power supply is controlled to present a higher voltage potential to the load than the output voltage level range presented by a second power supply, under normal operating conditions by controlling the source voltage to the first power supply FET OR circuit and the second power supply FET OR circuit. The voltage potential difference between the first power supply source and the second power supply source is such that the primary supply sources all of the current requirements under all operating environment of the load while the second power supply remains in an energized standby mode.

In one embodiment, after the voltage programming, the first power supply continues to source current to the load until there is a fault condition or a failure of the first power supply that cuts off current supply to the load. Under such a situation, the second power supply takes over the role of the failed first power supply because the second power supply presents a higher potential to the load in the absence of the failed power supply. A power module controller adjusts the voltage output of the secondary power supply so that it matches the voltage output of the primary power supply before the fault condition.

In one embodiment, the present invention can schematically be represented by a circuit where the current is not forced through a diode for redundancy by switching the FET switch ON in one power supply and Off in the second power supply. The FET switches are ON both of the supplies and the source voltage level of the first power supply and the source voltage level of second power supply are controlled to let the first power supply source the load and the second power supply serve as redundant back up power supply. In this embodiment a diode is used for reverse current protection only.

An advantage of the one embodiment of the present invention is that the voltage level range based load switching architecture permits the use of a primary supply to source the low voltage loads, like the management power in the MicroTCA specification which is 3.3+/−10% Volts, while the second power supply is in the standby mode, where a diode-drop based redundancy fails to meet this feature.

An advantage of one embodiment of the present invention is that the voltage level range based load switching architecture permits the use of regulated, unregulated or semi-regulated power supplies in an arrangement that can meet the redundancy requirements of standards like the MicroTCA specification while overcoming the limitations of the diode-drop based redundancy configuration. The use of such unregulated or semi-regulated power supplies can provide for reduced part count and higher power densities to meet the compact board space requirement, smaller thermal losses, lower component cost, simple circuitry and non-complex control of power supplies for next generation electronics.

### BRIEF DESCRIPTION OF THE INVENTION

FIG. 1A is prior art of Payload Power Redundancy Model of MicroTCA Specification.

FIG. 1B is prior art of Management Power Redundancy Model of MicroTCA Specification.

FIG. 2A illustrates the redundant power supply architecture of the present invention utilizing a well-regulated, semi-regulated and unregulated power supplies.

FIG. 2B is a graphical representation of the voltage (or power) levels arranged into ranges of an exemplary power level range based redundant configuration according to the present invention.

FIGS. 2C and 2D illustrate the voltage ranges for MicroTCA Payload power (12V) and MicroTCA management power, respectively to provide redundancy according to the present invention.

FIG. 3A illustrates the ORing FETs with the appropriate voltage ranges for the primary and the redundant supplies according to the present invention; FIG. 3B illustrates the current flows in the primary and the redundant supplies according to the present invention.

FIGS. 4A and 4B illustrate the operation of an exemplary circuit to realize the voltage level ranges of the illustration of FIG. 2B.

### DETAILED DESCRIPTION OF THE PREFERRED EMBODIMENTS

One embodiment of the present invention is schematically illustrated in the FIG. 2A. Power supplies A and B are isolated DC to DC converter. The power supplies A and B connected on the input side to a wide range input DC source of 36 Volts to 75 Volts. At the output side the Power supplies A and B are electrically coupled via a well known P Channel FETs to a load L1 and load L2, to provide redundancy and back up for loads L1 and load L2. The output of each power supply is FED back to the input side of each power supply to control PWM via a Output Voltage Controller (OVC). The Input of each power supply is also connected to each OVC. The controls of each OVC circuit are connected to the respective Power Module Controller. Discreet control pins A and B are provided for non controller based control of the OVC operation.

In regard to the present invention, the precise level of regulation of both of the power supplies is unimportant to provide active redundancy. What is important is that each DC/DC power converter is adjustable (programmable or otherwise) in that it can take as input a wide range of DC voltages Vin and output a DC voltage Vout. It is appreciated that the Vout of the Power supply is the Vin of the load connected to the supplies. The operating voltage input voltage and the tolerance of the loads is divided into three, distinct ranges. These are: a high (or maximum) voltage value range Vout HI and a low (or minimum) voltage value range Vout LO and a Guard Band voltage Range Vout GB, such that the relation Vout LO<Vout GB<Load HI is satisfied. FIG. 2B illustrate voltage level ranges for a generic load, FIG. 2C illustrates the voltage level ranges for the MicroTCA specification payload channel and FIG. 2D illustrate the voltage level ranges for the MicroTCA specification management power. These ranges can be attained by one of the appropriate OVC adjustment methods explained in the latter sections. In operation power modules A and B are selectively adjusted such that the output voltage of a first power supply A varies within a first range Vout HI, while, the output voltage of the second power supply B varies within a second range Vout LO as illustrated in FIG. 2B. The ORing FETs with the appropriate voltage ranges for the primary and the redundant supplies according to the present invention is shown FIG. 3A. The current flow through the switches is schematically shown in FIG. 3B. It is appreciated that the Diodes is in the FIG. 3A are for protection of reverse current and has no function is providing the redundancy and therefore can be present anywhere in the electronic system where it can prevent current flowing back into power supplies from a redundant or back up power supply. The output voltage is sourced through the switch for both the primary and the redundant power supply by turning them ON. The voltage of the primary supply A to the load L is higher than the voltage level from the redundant supply B. The difference in potential of voltage presented by the power supply A and that supplied by power supply B is greater than the switching path losses, at least by the voltage represented by Vout GB.

It will be apparent to one of skill in the art that regardless of the level of regulation or the manner of power management/margining used, as long as the conditions illustrated in FIG. 2B are satisfied, the power supply with the higher voltage range Vout HI will always present the higher voltage potential at the load L1 or L2 of FIG. 2 A and therefore source all the current required by the load L1 or L2. Such a power supply will be the primary power supply in relation to the other power supply which will be relegated to remain energized but in a standby mode. In effect, the present invention segments the voltages level to ranges in the two power supplies so that one of them is always guaranteed to be the primary supply and the other is always guaranteed to be the redundant or standby under normal operating conditions. The diode voltage-drops are replaced by the differential, non-overlapping voltage level ranges of the present invention as illustrated and described. The voltage level range based architecture does not require precise regulation of the output voltages, nor does it require a complex control circuitry in the power module controller because the voltage levels in each power supply are sufficiently skewed to one of a high side or a low side such that minor output voltage variations, diode-drops and other transient phenomena do not cause an excursion of the output voltage levels of a power supply outside the high and low voltage limits associated with the power supply. Upon the occurrence of a fault condition, the switchover from primary to the redundant power supply is instantaneous with out any interruption in the operation of the load.

Thus, for example, in one embodiment of the present invention, the voltage ranges for the primary and the secondary are set to the voltage ranges depicted by graph shown FIG. 2C for the exemplary MicroTCA specification payload power. In another embodiment of the present invention, the voltage ranges are set to ranges depicted by the graph shown in FIG. 2D for the exemplary MicroTCA specification management power. In general, the voltage ranges can be tailored to the regulation tolerance of the load to affect redundancy.

One skilled in the art will readily recognize that the invention works for lower supply voltages, like the MicroTCA management power, which is 3.3+/−10% Volts, since diode drop is not involved in providing the redundancy.

One skilled in the art will further recognize that the restriction imposed on the regulation of output voltages for the providing diode based redundancy and there by eliminating power supplies with wider regulation limits for providing redundancy, such as the MicroTCA payload power of 12V+/−2.8% is over come with the present invention, making the semi-regulated power converters with +/−5% regulation or the unregulated voltage converters with a line regulation of +/−10% and a load regulation of +/−1.5% as well as the well regulated power converters less than +/−3% regulation, useful in the supporting the redundancy.

Another feature of the present invention is a method for adjusting the output voltage levels of each of the power supplies A and B such that they conform to the range of values presented in FIG. 4A. Referring again to the illustrations in FIG. 2A, the circuitry of power modules A and B include a power module controller communicatively coupled to an OVC. The power module controller may be embodied in an application specific integrated circuit “ASIC” although other devices and discrete component circuits may equally well be utilized within the scope of the present invention. The OVC either in conjunction with a power module controller or independently is operative to adjust the output voltage Vout of its power supply. The OVC can be controlled by power module controller system management bus, such as an I2C [I2C is an acronym for the Inter-IC bus that was developed by Phillips Corporation] interface or discrete digital signals or direct control pins, such as pins A and B of each power supply in FIG. 2A. The OVC adjustment may be programmable, manual or a combination of the two without digressing from the scope of the present invention. The function of the OVC can range from modulating the pulse width or modulating the pulse frequency or generating error voltages to control the out put voltage or current of the power converter using with feedback loops, feed forward loops or in an open loop arrangement.

In one embodiment of the present invention the voltage ranges for the purposes of providing redundancy according to the present invention can be obtained by modifying the reference voltage of an error amplifier to produce pulse width modulation to obtain a Vout Hi range or Vout LO range, as illustrated in FIG. 4A. The reference voltage to the error amplifier positive side can be selected to Vref Hi for the Vout HI range and Vref Lo for Vout LO range. The Vout of the converter is feed back to the error amplifier for voltage range adjustment. The reference voltages Vref Hi is selected to be the mid Point of the Vout Hi voltage Range, the reference voltage Vref LO is selected to be the midpoint of the Vout LO range. The Vout Range adjustment is accomplished by a programmable resistor Vout-range-adjust to derive the Vadjust voltage at the error amplifier. In this arrangement, for a chosen voltage range,

If Vadj=Vref, then Verror is Zero, the Duty cycle is maintained and Vout of the chosen range is maintained;
If Vadj>Vref, then Verror is Negative the Duty cycle is decreased to reduce the Vout of the chosen range;
If Vadj<Vref, then Verror is positive the Duty Cycle is Increased to increase the Vout of the chosen range.

The voltage level ranges for the purposes of providing redundancy according to the present invention can also be realized with the processes that are well known in the art. The Point of Load Alliance (POLA) sponsored by Texas Instruments Inc and others and Distributed-power Open Standards Alliance (DOSA) at www.dosapower.com, have published specification for DC-DC power converters. These specifications include the provisions for the output voltage adjustments. The power converters that do not meet the standards like POLA and DOSA have voltage adjustment provisions. The PWM control Integrated Circuits for constructing a DC to DC converter also provide facilities for voltage adjustments. These voltage adjustment provisions could be used for margining. The margining control function allows a power system to be adjusted so that the output voltage is between a value either above (margin up) or below (margin down) the nominal regulation voltage. FIG. 4B depicts an analog feedback loop adjustment with programmable resistor. In one exemplary embodiment of the present invention, the margining controller or a device having a function substantially similar to the margining controller is used to programmably or otherwise set the voltage ranges of each of the power supplies A and B to accord with the parameters shown in FIG. 2B. The digital potentiometer is incorporated into the OVC of each of the power supplies illustrated in FIG. 2A and used to derive the output voltage level ranges by controlling a trim resistor in the margining controller or by affecting the pulse width modulation as desired to set the voltage level ranges in accord with the parameters shown in FIG. 2B.

The end result in all of the above cases is that the output voltage of the power supply converter is substantially constrained within a desired range defined by a high voltage and a low voltage substantially independent of the variation of the input voltage or the load current. It must be appreciated that the scope of the present invention is not circumscribed by any particular margining/feed-back/power module controller scheme described above. Other circuitry may be used to set the output voltages of each of the power supply within the scope of the present invention. In effect, the present invention allows the margining functionality, that is typically used only in the design and testing phase, to be extended so that it can be activated during operation of the power supply converter to thereby provide redundancy without incurring a penalty in terms of cost, complexity, reliability and time-to-design associated with the prior art.

Finally, while the present invention has been described with reference to certain embodiments, those skilled in the art should appreciate that they can readily use the disclosed conception and specific embodiments as a basis for designing or modifying other structures for carrying out the same purposes of the present invention without departing from the spirit and scope of the invention as defined by the appended claims.

What is claimed is:

1. A switching, redundant, power supply architecture comprising:
at least two power supplies connected in parallel to a load via a FET OR circuit and maintained in an energized state; and
means for adjusting an output voltage level of each power supply such than an output voltage level range of a first power supply is controlled to present a higher voltage potential to the load than an output voltage level range presented by a second power supply under normal operating conditions by controlling a first source voltage to a FET OR circuit of the first power supply and second source voltage to a FET OR circuit of the second power supply,
whereby a voltage potential difference between the first source voltage and the second source voltage is such that the first power supply sources all of the current requirements under all operating environment of the load while the second power supply remains in an energized standby mode.

2. A redundant power supply method substantially as shown and described.

3. A redundant power supply substantially as shown and described.
